(19) United States
(12) Patent Application Publication
(10) Pub. No.: US 2019/0214037 A1
(43) Pub. Date: Jul. 11, 2019

(54) RECOMMENDATION DEVICE, RECOMMENDATION METHOD, AND NON-TRANSITORY COMPUTER-READABLE STORAGE MEDIUM STORING RECOMMENDATION PROGRAM

(71) Applicants: Toyota Jidosha Kabushiki Kaisha, Toyota-shi Aichi-ken (JP); DENSO TEN Limited, Kobe-shi Hyogo (JP)

(72) Inventors: Takashige Hori, Aisai-shi Aichi-ken (JP); Yohei Okamoto, Kobe-shi Hyogo-ken (JP); Masanobu Washio, Kobe-shi Hyogo-ken (JP); Tatsuya Kuwamoto, Kobe-shi Hyogo-ken (JP)

(73) Assignees: Toyota Jidosha Kabushiki Kaisha, Toyota-shi Aichi-ken (JP); DENSO TEN Limited, Kobe-shi Hyogo (JP)

(21) Appl. No.: 16/223,776

(22) Filed: Dec. 18, 2018

(30) Foreign Application Priority Data
Jan. 11, 2018 (JP) 2018-002916

(51) Int. Cl. G10L 25/63; G06N 5/04; G10L 15/22

(52) U.S. Cl. CPC G10L 25/63; G10L 15/30; G10L 15/22; G06N 5/04

(57) ABSTRACT

A recommendation device includes: a providing unit configured to provide recommendation information to a plurality of occupants in a vehicle; a sound collection device configured to collect a voice indicating a reaction of each occupant of the plurality of occupants to the recommendation information; a determination unit configured to determine whether the reaction of each occupant of the plurality of occupants to the recommendation information is a positive reaction or a negative reaction, based on the voice indicating the reaction of the occupant to the recommendation information; and an evaluation unit configured to evaluate an overall reaction of the plurality of occupants to the recommendation information, based on the reaction of each occupant of the plurality of occupants.

### CROSS-REFERENCE TO RELATED APPLICATIONS

This application claims priority to Japanese Patent Application No. 2018-002916 filed on Jan. 11, 2018, which is incorporated herein by reference in its entirety including the specification, drawings and abstract.

### BACKGROUND

### 1. Technical Field

The present disclosure relates to a recommendation device, a recommendation method, and a non-transitory computer-readable storage medium storing a recommendation program.

### 2. Description of Related Art

Providers who provide commodities or services (hereinafter, simply referred to as “commodities or the like”) provide users (consumers) with information for enhancing the users' willingness to purchase the commodities or the like (hereinafter, simply referred to as “recommendation information”). Japanese Unexamined Patent Application Publication No. 2017-182527 (JP 2017-182527 A) describes a technique in which a user's reaction to recommendation information is evaluated through voice analysis processing (e.g., frequency analysis processing or voice recognition processing). In the frequency analysis processing, variations in the tone of voice are detected. When the tone of a user's voice varies, for example, from a normal tone to a bright tone including a high frequency component, it is determined that the user shows a positive reaction to recommendation information. In the voice recognition processing, the voice indicating a user's reaction to recommendation information is converted into text information. The text information is broken down into keywords through known natural language processing, such as morphological analysis. Multiple keywords to which evaluations (positive evaluations or negative evaluations) are given in advance are compared with multiple keywords extracted from the voice indicating the user's reaction to the recommendation information. In this way, it is possible to determine whether the user shows a positive reaction to the recommendation information or shows a negative reaction to the recommendation information.

### SUMMARY

With the technique described in JP 2017-182527 A, it is possible to evaluate a single user's reaction to recommendation information. However, the technique described in JP 2017-182527 A is not adequate to evaluate an overall reaction of a plurality of users to recommendation information. For example, it is not possible to appropriately evaluate an overall reaction of a plurality of occupants in a vehicle to recommendation information.

The present disclosure provides a recommendation device, a recommendation method, and a non-transitory computer-readable storage medium storing a recommendation program, each of which makes it possible to appropriately evaluate an overall reaction of a plurality of occupants in a vehicle to recommendation information.

A first aspect of the disclosure relates to a recommendation device. The recommendation device includes a providing unit, a sound collection device, a determination unit, and an evaluation unit. The providing unit is configured to provide recommendation information to a plurality of occupants in a vehicle. The sound collection device is configured to collect a voice indicating a reaction of each occupant of the plurality of occupants to the recommendation information. The determination unit is configured to determine whether the reaction of each occupant of the plurality of occupants to the recommendation information is a positive reaction or a negative reaction, based on the voice indicating the reaction of the occupant to the recommendation information. The evaluation unit is configured to evaluate an overall reaction of the plurality of occupants to the recommendation information, based on the reaction of each occupant of the plurality of occupants.

In the recommendation device according to the first aspect of the disclosure, the providing unit may be configured to provide the recommendation information through use of at least one of an image or a voice.

In the recommendation device according to the first aspect of the disclosure, the evaluation unit may be configured to evaluate the overall reaction of the plurality of occupants to the recommendation information, based on the reaction of each occupant of the plurality of occupants, to which a weight individually determined for the occupant is assigned.

In the recommendation device according to the first aspect of the disclosure, the evaluation unit may be configured to evaluate the overall reaction of the plurality of occupants to the recommendation information, based on the reaction of each occupant of the plurality of occupants, to which the same weight is assigned.

A second aspect of the disclosure relates to a recommendation method. The recommendation method includes: providing, by a computer system, recommendation information to a plurality of occupants in a vehicle; collecting, by the computer system, a voice indicating a reaction of each occupant of the plurality of occupants to the recommendation information; determining, by the computer system, whether the reaction of each occupant of the plurality of occupants to the recommendation information is a positive reaction or a negative reaction, based on the voice indicating the reaction of the occupant to the recommendation information; and evaluating, by the computer system, an overall reaction of the plurality of occupants to the recommendation information, based on the reaction of each occupant of the plurality of occupants.

A third aspect of the disclosure relates to a non-transitory computer-readable storage medium storing a recommendation program. The recommendation program enables a computer system to execute: a step of providing recommendation information to a plurality of occupants in a vehicle; a step of collecting a voice indicating a reaction of each occupant of the plurality of occupants to the recommendation information; a step of determining whether the reaction of each occupant of the plurality of occupants to the recommendation information is a positive reaction or a negative reaction, based on the voice indicating the reaction of the occupant to the recommendation information; and a step of evaluating an overall reaction of the plurality of occupants to the recommendation information, based on the reaction of each occupant of the plurality of occupants.

With the recommendation device, the recommendation method, and the non-transitory computer-readable storage medium storing the recommendation program according to the foregoing aspects of the disclosure, it is possible to appropriately evaluate an overall reaction of a plurality of occupants in a vehicle to recommendation information.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a block diagram illustrating the hardware configuration of an in-vehicle device according to an embodiment; and

FIG. 2 is a block diagram illustrating the functional configuration of the in-vehicle device according to the embodiment.

### DETAILED DESCRIPTION OF EMBODIMENTS

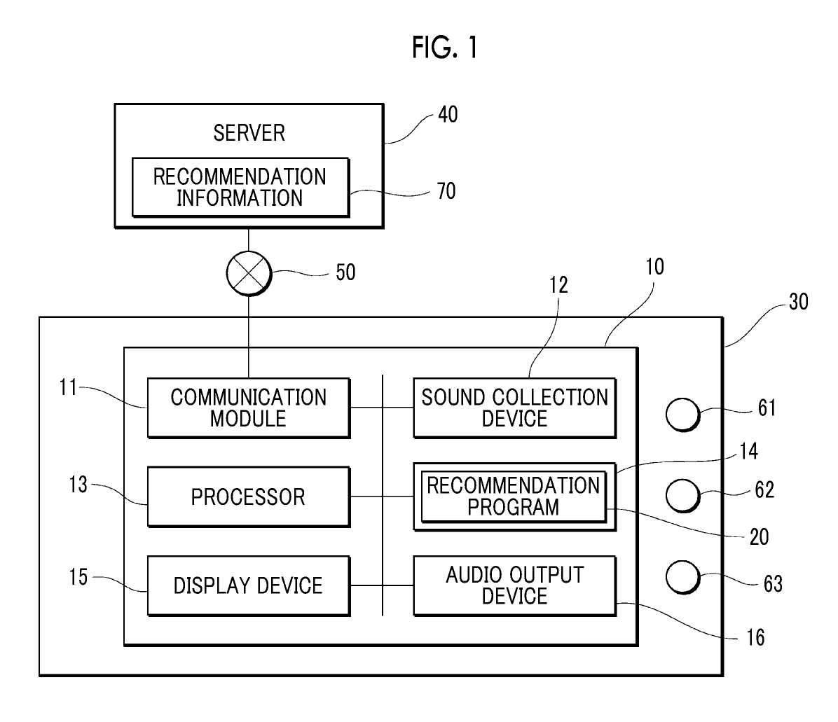

Hereinafter, example embodiments will be described with reference to the accompanying drawings. Note that, the same reference signs represent the same constituent elements, and overlapping description will be omitted. FIG. 1 is block diagram illustrating the hardware configuration of an in-vehicle device 10 according to an embodiment. The in-vehicle device 10 may be, for example, a multimedia system (e.g., an in-vehicle navigation system, or an in-vehicle audio system) mounted in a vehicle 30, or may be a portable terminal (e.g., a multifunction mobile phone called a smartphone, or a tablet terminal). The in-vehicle device 10 is configured to be connected to a server 40 through a network 50. The server 40 is a host computer configured to generate and transmit recommendation information 70 about commodities or the like. The in-vehicle device 10 functions as a device configured to receive the recommendation information 70 from the server 40 through the network 50 and then provide the recommendation information 70 to a plurality of occupants (e.g., a driver and passengers) 61, 62, 63 in the vehicle 30 (hereinafter, the device will be simply referred to as “recommendation device”). The recommendation device executes processing for providing the recommendation information 70 to the occupants 61, 62, 63 and processing for evaluating reactions (responses) of the occupants 61, 62, 63 to the recommendation information 70. The processings executed by the recommendation device will be referred to as “recommendation method”.

The in-vehicle device 10 is a computer system including, as hardware resources, a communication module 11, a sound collection device 12, a processor 13, a storage device 14, a display device 15, and an audio output device 16.

The communication module 11 is configured to execute processing for controlling mobile communication between the in-vehicle device 10 and the server 40 through the network 50. The network 50 is, for example, a communication network where a wireless network and a wired network are mixed. Examples of the wireless network include mobile communication network, satellite communication network, Bluetooth (BLE (Registered Trademark)), Wireless Fidelity (WiFi (Registered Trademark)), and High Speed Downlink Packet Access (HSDPA). Examples of the wired network include Local Area Network (LAN), Wide Area Network (WAN), and Value Added Network (VAN).

The sound collection device 12 may be an internal microphone incorporated in the in-vehicle device 10 or an external microphone (an external wired microphone or a wireless microphone).

A computer program 20 that enables the in-vehicle device 10 to execute the recommendation method (hereinafter, the computer program 20 will be simply referred to as “recommendation program 20”) is stored in the storage device 14. The processor 13 is configured to interpret and execute the recommendation program 20 stored in the storage device 14, thereby executing the recommendation method through control of various hardware resources of the in-vehicle device 10. The storage device 14 is a computer readable recording medium, such as a semiconductor memory (a volatile memory or a nonvolatile memory) or a disk medium (an optical recording medium or a magneto-optical recording medium).

The recommendation information 70 may be image information, voice information, or information generated by combining image information and voice information together. The display device 15 is a display (e.g., a liquid crystal display, an electroluminescence display, or a plasma display) configured to display the recommendation information 70 as image information. The audio output device 16 is a speaker configured to output the recommendation information 70 as voice information.

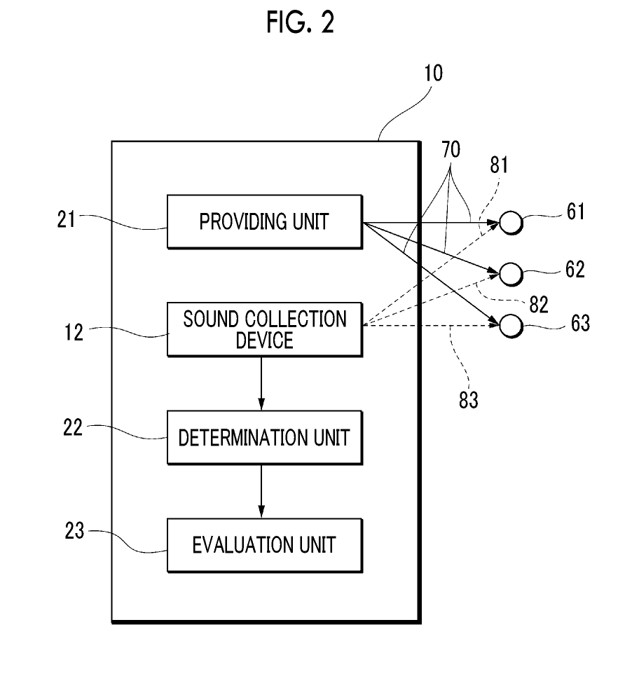

FIG. 2 is a block diagram illustrating the functional configuration of the in-vehicle device 10 according to the embodiment. A function as a providing unit 21 is implemented by one of the display device 15 and the audio output device 16 or is implemented through cooperation between the display device 15 and the audio output device 16. For example, when the recommendation information 70 includes image information and does not include voice information, the display device 15 functions as the providing unit 21. For example, when the recommendation information 70 includes voice information and does not include image information, the audio output device 16 functions as the providing unit 21. For example, when the recommendation information 70 includes information generated by combining image information and voice information together, the function as the providing unit 21 is implemented through cooperation between the display device 15 and the audio output device 16. The providing unit 21 is configured to provide the recommendation information 70 to the occupants 61, 62, 63.

A function as a determination unit 22 and a function as an evaluation unit 23 are implemented through cooperation between the various hardware resources of the in-vehicle device 10 and the recommendation program 20. The recommendation program 20 may include, for example, a plurality of software modules to be called and executed in a main program. The software modules are sub-programs modularized in order to execute processing for implementing the function as the determination unit 22 and processing for implementing the function as the evaluation unit 23. The functions similar to the function as the determination unit 22 and the function as the evaluation unit 23 may be implemented by dedicated hardware resources (e.g., application specific integrated circuits) or firmware.

The sound collection device 12 collects voices 81, 82, 83 respectively indicating reactions of the occupants 61, 62, 63 to the recommendation information 70. The determination unit 22 determines individually whether the reaction of each of the occupants 61, 62, 63 is a positive reaction or a negative reaction based on the voices 81, 82, 83 respectively indicating individual reactions of the occupants 61, 62, 63 to the recommendation information 70. The evaluation unit 23 evaluates an overall reaction of the plurality of occupants 61, 62, 63 based on the individual reactions of the occupants 61, 62, 63.

A method of evaluating an overall reaction of the plurality of occupants 61, 62, 63 based on the individual reactions of the occupants 61, 62, 63 may be classified broadly into a first evaluation method and a second evaluation method. In the first evaluation method, the same weight is assigned to the reaction of each of the occupants 61, 62, 63, and an overall reaction of the plurality of occupants 61, 62, 63 is evaluated based on the reactions of the occupants 61, 62, 63 to which the same weight is assigned. On the other hand, in the second evaluation method, a weight individually determined for each of the occupants 61, 62, 63 is assigned to the reaction of the corresponding one of the occupants 61, 62, 63, and an overall reaction of the plurality of occupants 61, 62, 63 is evaluated based on the reactions of the occupants 61, 62, 63 to which the individually determined weights are assigned.

First, the first evaluation method will be described. The determination unit 22 identifies the voices 81, 82, 83 respectively indicating the reactions of the occupants 61, 62, 63 to the recommendation information 70, according to a known speaker identification algorithm. In some embodiments, the speaker identification algorithm is a speaker identification algorithm using a vector quantization method in which, for example, a mel-frequency cepstrum coefficient (MFCC) indicating human aural characteristics and an amount of change ΔMFCC in the mel-frequency cepstrum coefficient are used as feature parameters for identifying a speaker. A mel-frequency cepstrum is obtained by splitting a spectrum of a voice wave at frequency intervals close to a human sense of hearing and executing a cepstrum process. It is a known fact that the human sense of hearing has a fine frequency resolution at a low frequency and has a coarse frequency resolution at a high frequency. This is called a mel scale, and the mel scale shows a nonlinear characteristic close to a logarithm. It is necessary to extract time-series data for each frequency component from a voice spectrum in order to recognize a voice. However, band filters may be arranged at regular intervals on a logarithmic frequency scale or on a mel scale in order for a frequency band filter used for recognizing a voice to meet the human sense of hearing.

The determination unit 22 converts the voices 81, 82, 83 into text information and breaks the text information down into keywords, for example, through known natural language processing, such as morphological analysis. A dictionary database is stored in the storage device 14. The dictionary database stores multiple keywords to which evaluations (positive evaluations or negative evaluations) are given in advance. The determination unit 22 compares the keywords extracted from the voices 81, 82, 83 with the keywords stored in the dictionary database, thereby determining whether the reaction of each of the occupants 61, 62, 63 to the recommendation information 70 is a positive reaction or a negative reaction. Here, evaluation parameters C1, C2, C3 for respectively evaluating the reactions of the occupants 61, 62, 63 to the recommendation information 70 will be defined as follows. When the reaction of the occupant 61 is a positive reaction, the evaluation parameter C1 takes a value of “1” (C1=1), whereas when the reaction of the occupant 61 is a negative reaction, the evaluation parameter C1 takes a value of “−1” (C1=−1). When the reaction of the occupant 62 is a positive reaction, the evaluation parameter C2 takes a value of “1” (C2=1), whereas when the reaction of the occupant 62 is a negative reaction, the evaluation parameter C2 takes a value of “−1” (C2=−1). When the reaction of the occupant 63 is a positive reaction, the evaluation parameter C3 takes a value of “1” (C3=1), whereas when the reaction of the occupant 63 is a negative reaction, the evaluation parameter C3 takes a value of “−1” (C3=−1). The evaluation unit 23 calculates an overall evaluation parameter C for evaluating an overall reaction of the plurality of occupants 61, 62, 63 according to Expression (1).

C=C1+C2+C3 Expression (1)

The evaluation unit 23 evaluates an overall reaction of the plurality of occupants 61, 62, 63 based on the value of the overall evaluation parameter C calculated by Expression (1). When the value of the overall evaluation parameter C is a positive value, the overall reaction of the plurality of occupants 61, 62, 63 is evaluated to be positive. In particular, the greater the value of the overall evaluation parameter C is, the higher the evaluation given to the overall reaction of the plurality of occupants 61, 62, 63 is. When the value of the overall evaluation parameter C is a negative value, the overall reaction of the plurality of occupants 61, 62, 63 is evaluated to be negative. In particular, the smaller the value of the overall evaluation parameter C is, the lower the evaluation given to the overall reaction of the plurality of occupants 61, 62, 63 is. When the number of occupants of the vehicle 30 is an even number, the number of occupants who show positive evaluation is equal to the number of occupants who show negative evaluation, so that the value of the overall evaluation parameter C becomes zero, in some cases. In such a case, an overall reaction of a plurality of occupants is evaluated to be neutral, that is, the overall reaction of the plurality of occupants is evaluated to be neither positive nor negative. The first evaluation method is the same as an evaluation method called majority decision.

Next, the second evaluation method will be described. The determination unit 22 identifies the voices 81, 82, 83 respectively indicating the reactions of the occupants 61, 62, 63 to the recommendation information 70 and determines whether the reaction of each of the occupants 61, 62, 63 is a positive reaction or a negative reaction, in the same manner as that in the first evaluation method. Information indicating weighting coefficients K1, K2, K3 for respectively evaluating the reactions of the occupants 61, 62, 63 to the recommendation information 70 is stored in the storage device 14 in advance. The evaluation unit 23 calculates an overall evaluation parameter C for evaluating an overall reaction of the plurality of occupants 61, 62, 63 according to Expression (2). Note that, although the condition that the weighting coefficients K1, K2, K3 are equal to one another (K1=K2=K3) should not be satisfied, the condition that the weighting coefficients K1, K2, K3 are different from one another (K1≠K2≠K3) need not be satisfied.

C=K1×C1+K2×C2+K3×C3 Expression (2)

The evaluation unit 23 evaluates an overall reaction of the plurality of occupants 61, 62, 63 based on the value of the overall evaluation parameter C calculated by Expression (2). The method of evaluating an overall reaction of the plurality of occupants 61, 62, 63 according to Expression (2) is similar to the method of evaluating an overall reaction of the plurality of occupants 61, 62, 63 according to Expression (1). Note that, the value of the overall evaluation parameter C becomes zero in some cases, depending on the values of the weighting coefficients K1, K2, K3 and the values of the evaluation parameters C1, C2, C3. In such a case, an overall reaction of the plurality of occupants 61, 62, 63 is evaluated to be neutral, that is, the overall reaction of the plurality of occupants 61, 62, 63 is evaluated to be neither positive nor negative. The second evaluation method is obtained by modifying the evaluation method called majority decision, such that the weighting coefficients K1, K2, K3 determined respectively for the occupants 61, 62, 63 are used in the second evaluation method. In the second method, a higher importance is assigned to an individual reaction of an occupant to which a greater weighting coefficient is given than to individual reactions of the other occupants, and a lower importance is assigned to an individual reaction of an occupant to which a smaller weighting coefficient is given than to individual reactions of the other occupants.

The communication module 11 transmits information indicating a result of evaluation on the overall reaction of the plurality of occupants 61, 62, 63 to the server 40 through the network 50. The server 40 that has received the information indicating the result of evaluation on the overall reaction of the plurality of occupants 61, 62, 63 analyzes the preference of the occupants 61, 62, 63 for commodities or the like. Then, the result of analysis is utilized to improve the effect of recommendation.

Note that, the determination unit 22 may identify the voices of the occupants 61, 62, 63 according to a method other than the speaker identification algorithm. The seating positions of the occupants 61, 62, 63 in the vehicle 30 are not changed unless the occupants 61, 62, 63 change seats. Therefore, a directional microphone may be used as the sound collection device 12, whereby the determination unit 22 identifies the voice of each of the occupants 61, 62, 63 based on a direction of propagation of the voice. Alternatively, the sound collection devices 12 may be attached respectively to the seats in the vehicle 30, whereby the determination unit 22 identifies the voices of the occupants 61, 62, 63 based on voice signals collected by the sound collection devices 12.

In the above description, the number of occupants in the vehicle 30 is three. However, the number of occupants in the vehicle 30 may be two or may be four or more.

The foregoing embodiment has been described in detail, and the foregoing embodiment is not intended to limit the technical scope of the disclosure. Various changes and modifications may be made to the foregoing embodiment within the technical scope of the disclosure, and the disclosure is intended to cover various equivalent arrangements.

What is claimed is:

1. A recommendation device comprising:
a providing unit configured to provide recommendation information to a plurality of occupants in a vehicle;
a sound collection device configured to collect a voice indicating a reaction of each occupant of the plurality of occupants to the recommendation information;
a determination unit configured to determine whether the reaction of each occupant of the plurality of occupants to the recommendation information is a positive reaction or a negative reaction, based on the voice indicating the reaction of the occupant to the recommendation information; and
an evaluation unit configured to evaluate an overall reaction of the plurality of occupants to the recommendation information, based on the reaction of each occupant of the plurality of occupants.

2. The recommendation device according to claim 1, wherein the providing unit is configured to provide the recommendation information through use of at least one of an image or a voice.

3. The recommendation device according to claim 1, wherein the evaluation unit is configured to evaluate the overall reaction of the plurality of occupants to the recommendation information, based on the reaction of each occupant of the plurality of occupants, to which a weight individually determined for the occupant is assigned.

4. The recommendation device according to claim 3, wherein the evaluation unit is configured to evaluate the overall reaction of the plurality of occupants to the recommendation information, based on the reaction of each occupant of the plurality of occupants, to which the same weight is assigned.

5. A recommendation method comprising:
providing, by a computer system, recommendation information to a plurality of occupants in a vehicle;
collecting, by the computer system, a voice indicating a reaction of each occupant of the plurality of occupants to the recommendation information;
determining, by the computer system, whether the reaction of each occupant of the plurality of occupants to the recommendation information is a positive reaction or a negative reaction, based on the voice indicating the reaction of the occupant to the recommendation information; and
evaluating, by the computer system, an overall reaction of the plurality of occupants to the recommendation information, based on the reaction of each occupant of the plurality of occupants.

6. A non-transitory computer-readable storage medium storing a recommendation program that enables a computer system to execute:
a step of providing recommendation information to a plurality of occupants in a vehicle;
a step of collecting a voice indicating a reaction of each occupant of the plurality of occupants to the recommendation information;
a step of determining whether the reaction of each occupant of the plurality of occupants to the recommendation information is a positive reaction or a negative reaction, based on the voice indicating the reaction of the occupant to the recommendation information; and
a step of evaluating an overall reaction of the plurality of occupants to the recommendation information, based on the reaction of each occupant of the plurality of occupants.
